(19) United States
(12) Patent Application Publication
(10) Pub. No.: US 2024/0115891 A1
(43) Pub. Date: Apr. 11, 2024

(54) ADMIXING SYSTEM FOR FIRE-EXTINGUISHING UNITS AND METHOD FOR THE MAINTENANCE THEREOF

(71) Applicant: FIREDOS GMBH, Wölfersheim (DE)

(72) Inventors: Fritz ZIMMERMANN, Gerstetten (DE); Andreas HULINSKY, Dresden (DE); Jörn ERLENMAIER, Niddatal (DE)

(21) Appl. No.: 18/554,962

(22) PCT Filed: Apr. 8, 2022
(86) PCT No.: PCT/EP2022/059366

§ 371 Date: Oct. 11, 2023

(30) Foreign Application Priority Data
Apr. 13, 2021 (DE) 10 2021 203 613.9

(51) Int. Cl. A62C 5/02; A62C 31/12; A62C 37/36

(52) U.S. Cl. CPC A62C 5/02; A62C 31/12; A62C 37/04

(57) ABSTRACT

The invention relates to an admixing system for fire-extinguishing units, for producing a mixture of a fire extinguishant and a fire extinguishant additive (premix) by admixing a fire extinguishant additive, in particular a foaming agent, into a fire extinguishant, in particular water, said admixing system comprising a motor that can be driven by a fire extinguishant flow, and a mixing pump used to deliver the fire extinguishant additive, which is coupled to the motor and driven thereby. The admixing system comprises remote control means for transmitting and executing a command for the automatic start-up or shut-down of the motor and the mixing pump, as well as remote read-out means for automatically detecting and transmitting data relating to the state of the admixing system. The presence of an operator is therefore not required with the admixing system. These remote maintenance functions allow the operability of the admixing system to be verified without an operator having to physically go to the fire extinguishing unit with the admixing system, thereby significantly reducing the complexity and related maintenance costs.

The entire content of priority application DE 10 2021 203 613.9 is hereby incorporated into the present application by reference.

The present invention relates to an admixing system for fire-extinguishing units and a method for the maintenance thereof. A fire-extinguishing unit in the sense of the present invention is a system comprising a pump, a line system and an admixing system for a fire extinguishant additive enabling the deployment of a fire extinguishant, in particular via nozzles, foam tubes or foam generators. The fire-extinguishing unit can be a stationary system such as a fire-extinguishing unit in a tank farm with a permanently mounted so-called monitor; i.e. a large jet nozzle, or a permanently installed sprinkler system in a building. But it can also be a mobile system on a vehicle or roll-off container.

Such fire-extinguishing units are normally operated with water as the fire extinguishant. Although in many cases it is advantageous to foam the fire extinguishant prior to spreading it onto the fire to be fought so that the fire extinguishant applied forms a long-lasting extinguishing blanket able to smother the fire. To that end, a fire extinguishant additive, in this case a foaming agent, is usually first added to the extinguishant at a specific ratio. The mixture of fire extinguishant and fire extinguishant additive (the so-called “premix”) is then foamed in a nozzle upon being supplied with air and spread onto the fire to be extinguished. The volume ratio of fire extinguishant additive to fire extinguishant, the so-called admixture rate, is typically between 0.5% and 6%.

Another fire extinguishant additive able to be mixed with the fire extinguishant is a surfactant or “wetting agent” which decreases the surface tension of the fire extinguishant, in particular the extinguishing water. This is advantageous when fighting forest fires, for example, because the extinguishing water is thereby able to wet down larger areas, particularly on the leaves of trees, and can thus be deployed more efficiently. Furthermore, the reduced surface tension allows the extinguishing water to soak down deeper into the forest floor, for example in order to extinguish deeper hot spots.

There are also foaming agents likewise able to be used as wetting agents (then possibly at different admixture rates, in particular at a minimum admixture rate of 0.1%).

The invention is in part described in the following using the example of water as a fire extinguishant and a foaming agent as a fire extinguishant additive. However, this is not to be construed as limiting. The invention can just as equally be used when mixing any fire extinguishant additive with any fire extinguishant.

To operate the fire-extinguishing unit with the admixing system, both the fire extinguishant as well as the fire extinguishant additive can be provided from an extinguishant tank or an extinguishant additive tank or also via an extinguishant supply line or extinguishant additive supply line. When the fire extinguishant is provided in an extinguishant tank, an extinguishing agent pump which pumps the fire extinguishant from the fire extinguishant tank, pressurizes it and supplies it to the admixing system is also required. However, these noted components are not necessarily part of the admixing system itself.

In the case of a foaming agent as a fire extinguishant additive, the mixture to be produced from the fire extinguishant and the fire extinguishant additive; i.e. the premix, is then channeled as a premix flow through a foaming nozzle in which ambient air sucked in by the premix flow is mixed with the premix. This activates the foaming agent in the premix and foams the premix so that a fire extinguishant foam is discharged from the foaming nozzle and can be applied to the fire.

The air required to foam the foaming agent can also be supplied to the premix in the form of compressed air. Such a system which produces compressed air foam is referred to as a OAFS system (Compressed Air Foam System).

Although it is possible to produce the premix in advance independent of the fire-extinguishing unit, it might then need to be stored for a longer period of time. In many cases it is therefore more advantageous to produce the premix immediately before the fire extinguishant is applied to the fire to be fought. To that end, the admixing system has a mixing pump via which the fire extinguishant additive can be pumped and mixed into the fire extinguishant.

In the admixing system considered for the present invention, the mixing pump is driven by a motor which is in turn driven by a flow of the fire extinguishant itself.

In the aforementioned non-limiting application example of the invention, the admixing system thus has a water motor which is driven by the flow of extinguishing water. For this purpose, the output shaft of the water motor is coupled to the input shaft of the mixing pump, for example by a coupler.

The fire extinguishant additive pumped by the mixing pump is then directed through an extinguishant additive outlet line from the mixing pump into a mixing line where it is mixed into the flow of extinguishant in order to produce the premix.

This structure of the admixing system, with the mixing pump being driven by the flow of fire extinguishant which would in any event be present anyway, has the advantage of the mixing pump not requiring any external operating power, in particular electricity, whereby the admixing system is highly fail-safe. Furthermore, the delivery rate of the mixing pump is substantially proportional to the speed of the motor which is in turn substantially proportional to the flow rate of the fire extinguishant. This thereby automatically achieves a substantially constant admixture rate without the need for further control or regulating devices.

Fire-extinguishing units and thus also admixing systems of the considered type, in particular stationary admixing systems, are often kept at the ready for a long time but only rarely used. Nevertheless, their consistent operational readiness is of the utmost importance. Therefore, the admixing systems must be regularly serviced and checked for operability. This usually entails an operator manually putting the admixing system into operation, verifying the admixing system's operability visually or by reading measuring instruments attached to the admixing system, and then manually taking the admixing system out of operation again. Particularly in the case of stationary admixing systems, this necessitates many personnel resources and associated costs, in particular for travel expenses and travel time.

The present invention is therefore based on the task of reducing the effort involved in maintaining an admixing system for a fire-extinguishing unit.

This task is solved by an admixing system according to claim 1 or a method for its maintenance according to claim 16 respectively. Advantageous developments of the invention are the subject matter of the subclaims.

The invention is based on an admixing system for fire-extinguishing units for producing a fire extinguishant and fire extinguishant additive mixture (premix) by mixing a fire extinguishant additive, in particular a foaming agent, into a fire extinguishant, in particular water.

The admixing system has the following components and lines:
a motor able to be driven by a flow of fire extinguishant, in particular a water motor, which has at least one feeding device for supplying the fire extinguishant to the motor, in particular from a fire extinguishant tank or from a fire extinguishant supply line, at least one output device for discharging the fire extinguishant from the motor, and a motor shaft able to be driven by the motor,
a fire extinguishant inlet line having a motor-side end connected to the at least one feeding device of the motor and a fire extinguishant supply-side end able to be connected in particular to a fire extinguishant tank or to a fire extinguishant supply line,
a mixing pump for pumping the fire extinguishant additive, preferably a piston pump and further preferably a plunger pump, which has a drive shaft coupled to the motor shaft of the motor, at least one feeding device for providing the fire extinguishant additive, in particular from an extinguishant additive tank or from an extinguishant additive supply line, and at least one output device for discharging the fire extinguishant additive,
a mixing line having a motor-side end and an outlet-side end, wherein the motor-side end is fluidly connected to the at least one output device of the motor,
a fire extinguishant additive line with a pump-side end and a mixing line-side end, wherein the pump-side end is fluidly connected to the at least one output device of the mixing pump and the mixing line-side end is fluidly connected to the mixing line at a mixing point.

According to the invention, the admixing system has remote control means for transmitting and executing a command for the automatic start-up or shut-down of the motor and of the mixing pump and/or timing means for the automatic start-up or shut-down of the motor and of the mixing pump, wherein the remote control means and/or the timing means allow the automatic start-up or respectively shut-down of the motor and of the mixing pump without the presence of an operator at the admixing system.

The timing means are thereby preferably designed so as to put the motor and the mixing pump into or out of operation according to a specific, in particular freely definable, timetable, preferably at specific time intervals and/or after a specific amount of time has passed since the last (automatic or manual) start-up or shut-down.

Both functions can of course also be combined; i.e. the remote control means simultaneously functioning as a timing means.

According to the invention, the admixing system further comprises remote read-out means for automatically receiving and transmitting data relating to the state of the admixing system, wherein the remote read-out means allows the automatic receiving and transmitting of this data without the presence of an operator at the admixing system.

These remote maintenance functions allow the operability of the admixing system to be verified without an operator having to physically go to the fire-extinguishing unit with the admixing system, which eliminates travel expenses. Particularly in the case of manufacturers with admixing systems in use all over the world, this can significantly reduce expenses and related maintenance costs.

According to one preferential embodiment of the invention, the admixing system further comprises a fire extinguishant pump for pumping fire extinguishant from a fire extinguishant tank and supplying to the motor, its at least one output device connected to the fire extinguishant supply-side end of the fire extinguishant inlet line, and the remote control means and/or the timing means are configured to start up and shut down the fire extinguishant pump.

This thereby creates a fire extinguishant flow in the fire extinguishant inlet line which drives the motor, whereby the mixing pump coupled to the motor is also driven and pumps fire extinguishant additive. The operability of all the substantial components of the admixing system can thus be tested.

According to one preferential alternative embodiment to the aforementioned embodiment of the invention, the fire extinguishant inlet line has a fire extinguishant valve for feeding fire extinguishant to the motor from a fire extinguishant supply line and the remote control means and/or the timing means are configured to open and close the fire extinguishant valve.

Provided the fire extinguishant in the fire extinguishant supply line is already under sufficient pressure, this also creates a fire extinguishant flow in the fire extinguishant inlet line. As in the aforementioned implementation, the operability of all substantial components of the admixing system can thereby be tested.

According to a further preferential embodiment of the invention, the admixing system further comprises a bypass line for the motor which is fluidly connected to the fire extinguishant inlet line at a motor input-side end and to the mixing line at a motor output-side end.

A line circuit is thereby created within the admixing system consisting of the part of the mixing line between the motor side-end of the mixing line and the motor output-side end of the bypass line, the bypass line itself and the part of the fire extinguishant inlet line between the motor input-side end of the bypass line and the motor-side end of the fire extinguishant inlet line. The motor is also arranged within this line circuit. It is thus possible for fire extinguishant to circulate through the line circuit and through the motor without fire extinguishant being supplied at the fire extinguishant supply-side end of the fire extinguishant inlet line and/or fire extinguishant being discharged at the outlet-side end of the mixing line. The admixing system can in this way be tested and maintained as a self-contained system with minimal logistical effort.

Particularly when the admixing system is a so-called “wet system;” i.e. the extinguishant lines are always filled with fire extinguishant—even in the event of lengthy non-operation of the admixing system—the cited line circuit is also always filled with fire extinguishant and thus does not require being specially filled with fire extinguishant for maintenance operations.

According to one preferential variant of the aforementioned embodiment, the admixing system further comprises a drive apparatus configured to set the motor into rotation and the motor is configured to pump the fire extinguishant contained in the previously described line circuit through said line circuit.

The motor being set into rotation by the drive apparatus and operating as a pump enables simple implementation of the aforementioned circulation of fire extinguishant in the line circuit and thus the self-contained test operation of the admixing system. At the same time, the motor also sets the mixing pump into operation and pumps the fire extinguishant additive, whereby all the substantial components of the admixing system can again be put into operation and tested.

According to one preferential variant thereof, the remote control means and/or the timing means are configured to start up and to shut down the drive apparatus.

This in turn readily enables the desired remote maintenance operation.

According to one preferential variant thereof, the drive apparatus is a drive motor, in particular an electric motor, its motor shaft being connected to the motor shaft of the motor for the fire extinguishant so as to selectively transmit torque, in particular via a freewheel and/or via a flexible coupling.

The drive motor and in particular the electric motor as a drive motor has the advantage of being readily usable with the remote control means and/or the timing means and being able to be put into or taken out of operation by them, in particular by electrical switching apparatus.

However, transmission of torque from the drive motor to the motor for the fire extinguishant should only occur during maintenance operation so that the motor works as a pump, delivers fire extinguishant and circulates it in the line circuit. Whereas during “real” operation of the admixing system in a firefighting operation, no torque is to be transmitted from the drive motor to the motor for the fire extinguishant.

In order to achieve the necessary selective decoupling of the drive motor from the motor for the fire extinguishant, a coupling can be used which is closed or opened depending on the operating mode of the admixing system. However, such a coupling constitutes a further component of the admixing system needing to be actively controlled. Preferentially, therefore, a mechanical freewheel is used which is configured so as to transmit torque from the rotating drive motor to the motor for the fire extinguishant during maintenance operation of the admixing system while allowing rotation of the extinguishing agent motor when the drive motor is at a standstill, in particular during “real” operation of the admixing system, whereby there is then no transmission of torque. The mechanical freewheel can be designed in the usual way, for example as a ratchet freewheel or roller freewheel.

Furthermore, a flexible coupling can also be arranged between the drive motor and the motor for the fire extinguishant, in particular in addition to the coupler or the freewheel, in order to prevent transmission of torque fluctuations of the drive motor or the motor for the fire extinguishant to the other motor or at least only allow their transmission once attenuated.

According to one preferential variant of the embodiment of the invention with a bypass line, the bypass line has a cut-off valve and the remote control means and/or the timing means are configured to open and close the cut-off valve.

This enables ensuring that the bypass line is only opened during maintenance operation and closed in “real” operation.

According to a further preferential variant of the embodiment of the invention with a bypass line, a switching device, in particular a ball valve, is arranged in the fire extinguishant additive line and further fluidly connected to a return line, wherein the switching device can be switched such that a flow of fire extinguishant additive from the pump-side end of the fire extinguishant additive line is selectively directed through the fire extinguishant additive line to the mixing point or into the return line, and wherein the remote control means and/or the timing means are configured to switch the switching device.

By switching the switching device, the flow of fire extinguishant additive during maintenance operation can thus be directed into the return line, which is preferably connected to the fire extinguishant additive tank and returns the fire extinguishant additive to same. This has the advantage of enabling operation of the mixing pump, which pumps fire extinguishant additive and at the same time circulates fire extinguishant in the line circuit, without the fire extinguishant additive getting into the mixing line.

According to a further preferential variant of the embodiment of the invention with a bypass line, the bypass line has at least one first measuring device, in particular a flow rate measuring device, preferably a magnetic-inductive flow meter, a pressure measuring device and/or a temperature measuring device, and the remote read-out means are configured to read data from the first measuring device and to transmit them.

Consequently, the measured values of the at least one first measuring device such as the flow rate, pressure and/or temperature of the fire extinguishant in the bypass line are provided and can be evaluated in order to verify the operability of the admixing system.

According to a further preferential embodiment of the invention, the mixing pump has at least one second measuring device, in particular an oil level sensor and/or an oil quality sensor, and the remote read-out means are configured to read data from the second measuring device and to transmit them.

Correspondingly, the measured values of the at least one second measuring device such as the oil level and/or the oil quality in the mixing pump are also available for evaluation.

According to a further preferential embodiment of the invention, the return line has at least one third measuring device, preferably a flow rate measuring device and more preferably a magnetic-inductive flow meter, and the remote read-out means are configured to read data from the third measuring device and to transmit them.

Correspondingly, the measured values of the at least one third measuring device such as the flow rate of the fire extinguishant additive in the return line are also available for evaluation.

According to a further preferential embodiment of the invention, the motor has at least one fourth measuring device, in particular a tachometer, and the remote read-out means are configured to read data from the fourth measuring device and to transmit them.

Correspondingly, the measured values of the at least one fourth measuring device such as the rotational speed of the motor are also available for evaluation

According to a further preferential embodiment of the invention, the remote control means are arranged remotely from the components of the admixing system for which the remote control means is configured to start up or shut down and/or the remote read-out means are arranged remotely from the components of the admixing system for which the remote read-out means is configured to receive data from and to transmit them, in particular on a remote server computer.

If the admixing system has timing means, same are preferably arranged at or near the components of the admixing system for which the timing means is configured to start up or shut down. The admixing system can thus utilize the timing means to “autonomously” control these components. It is also possible, however, for the remote control means to simultaneously have the function of timing means and then likewise be arranged remotely.

“Arranged remotely” is to be understood as the remote control/remote read-out means not being directly attached to the respective components of the admixing system. Instead, the remote control/remote read-out means can be connected to the admixing system via communication lines, preferably via telecommunications networks and further preferably via the internet. That means that they can be located in the same local building as the admixing system itself, in a different building on the premises of the admixing system's operator, at the admixing system's manufacturer or virtually anywhere else in the world. This allows the desired remote maintenance while saving travel time and travel costs for the maintenance personnel.

According to a further preferential embodiment of the invention, the data transmitted by the remote read-out means can be stored remotely from the components of the admixing system for which the remote read-out means is configured to receive data from and to transmit them, in particular in a remote server computer memory or in a cloud storage.

In accordance with the common information technology term of “cloud computing,” the term “cloud storage” refers to data storage able to be distributed over a plurality of physical storage points and their geographical location(s) conceivably not even being known to the user of the cloud storage. Typically, the user can access the cloud storage over the internet and use it in a similar manner as if it were installed on a local computer.

The same thus applies to the received and transmitted data as to the remote maintenance and remote read-out means themselves, namely that they can be stored at virtually any location in the world for preferably immediate or later evaluation, in particular by way of a comparison to predetermined target values, earlier data from the same admixing system or data from other admixing systems.

An inventive method for maintenance of an inventive admixing system has the following steps:
the remote control means and/or timing means starting up the motor and the mixing pump,
the remote read-out means receiving and transmitting data relating to the state of the admixing system, and
the remote control means and/or timing means shutting down the motor and the mixing pump.

So doing realizes the desired remote maintenance operation without maintenance personnel having to physically go to the fire-extinguishing unit and the admixing system itself.

In one preferential embodiment of the inventive method, wherein the admixing system has a bypass line, the following step is performed prior to starting up the motor and the mixing pump:
the remote control means and/or timing means switching the switching device in the fire extinguishant additive line such that a flow of fire extinguishant additive is directed from the pump-side end of the fire extinguishant additive line into the return line.

Furthermore, the following step is performed subsequent to shutting down the motor and the mixing pump:
the remote control means and/or timing means switching the switching device in the fire extinguishant additive line such that a flow of fire extinguishant additive is directed through the fire extinguishant additive line from the pump-side end of the fire extinguishant additive line to the mixing point.

The advantages of this embodiment of the method are analogous to the corresponding above-described embodiment of the admixing system.

Additionally, another valve in the return line can be opened or closed prior to the motor and the mixing pump being put into operation and after the motor and the mixing pump have been taken out of operation in order to enable or respectively prevent the outward flow of fire extinguishant additive through the return line.

Further advantages, features and possible applications of the present invention yield from the following description in conjunction with the FIGURE. Shown therein:

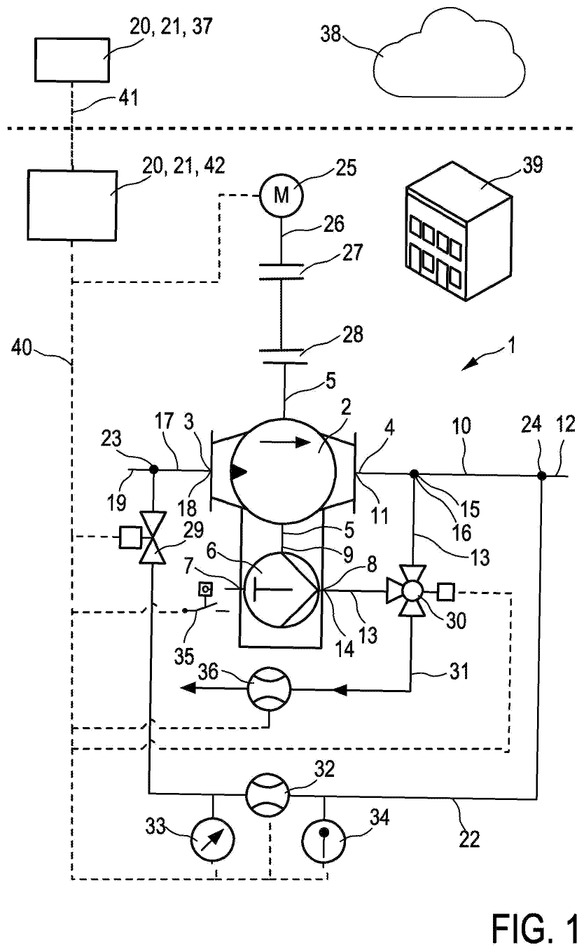

FIG. 1 a flow diagram of an inventive admixing system as well as a schematic depiction of the remote maintenance and remote read-out means and the communication lines for their connection.

The following will first describe the “real” operation of the admixing system 1; i.e. the use of the admixing system 1 to extinguish a fire.

The admixing system 1 is supplied with extinguishing water pumped out of an extinguishing water tank by an extinguishing water pump (neither depicted) and thereby pressurized. The extinguishing water then flows through the fire extinguishant inlet line 17 from its fire extinguishant supply-side end 19 to and into the feeding device 3 of the water motor 2 in order to drive it. The water motor 2 preferably works pursuant to the displacement principle, further preferably pursuant to the reciprocating piston or the rotation principle.

At the output device 4 of the water motor 2, the extinguishing water reaches the motor-side end 11 of the mixing line 10.

The motor shaft 5 of the water motor 2 is connected to the drive shaft 9 of a mixing pump 6, preferably via a coupling (not depicted). The drive shaft 9 of the mixing pump 6 is also set into rotational motion along with the motor shaft 5 of the water motor 2, whereby the mixing pump 6 is driven. The mixing pump 6 is preferably a plunger pump.

The mixing pump 6 pumps a fire extinguishant additive, in particular a foaming agent provided in a fire extinguishant additive tank (not depicted), and channels it to the feeding device 7 of the mixing pump 6. It is sucked in there by the mixing pump 6 which pressurizes it and pumps it to the output device 8 of the mixing pump 6.

At the output device 8 of the mixing pump 6, the fire extinguishant additive reaches the pump-side end 14 of the fire extinguishant additive line 13.

The fire extinguishant additive in the fire extinguishant additive line 13 first encounters a three-way ball valve 30 and, when this is in the “Admix” position, then reaches the mixing line-side end 15 of the fire extinguishant additive line 13 where it connects to the mixing line 10. This is also the location of the mixing point 16 at which the fire extinguishant additive is mixed into the extinguishing water.

By synchronizing the flow rates of the extinguishing water flow in the mixing line 10 and the fire extinguishant additive flow in the fire extinguishant additive line 13, the volume ratio between the admixed fire extinguishant additive and extinguishing water; i.e. the admixture rate, is substantially constant, e.g. 3%, due to the coupling of the water motor 2 and the mixing pump 6.

The extinguishing water thereby mixed with the fire extinguishant additive; i.e. the premix, is ultimately directed through the mixing line 10 to its outlet end 12 and from there dispensed to the fire-extinguishing unit's points(s) of use, for example to one or more sprinkler nozzles or even a foaming nozzle and an extinguishing monitor (none depicted).

In “real” operation of the admixing system 1, the cut-off valve 29 in the bypass line 22, to be described in greater detail below, is closed so that no extinguishing water can flow from the mixing line 10 into the bypass line 22 at the motor output-side end 24 of the bypass line 22.

In addition to “real” operation when used to extinguish a fire, the admixing system 1 can also be operated in a maintenance operation which will now be described.

For this purpose, the admixing system 1 comprises remote control means 20, by means of which a command can be transmitted for automatically starting up or shutting down the water motor 2 and the mixing pump 6, as well as remote read-out means 21, by means of which data relating to the state of the admixing system 1 can be automatically received and transmitted.

Additionally or alternatively, timing means for automatically starting up or shutting down the water motor 2 and the mixing pump 6 can also be provided. However, this is not depicted in the exemplary embodiment.

The remote control means 20 and the remote read-out means 21 can be arranged within a local building 39, connected by a signal/control line 40 or, via an additional internet connection 41 link, can be situated at any other location. The remote control means 20 and/or the remote read-out means 21 can in particular be arranged in a local programmable logic controller (PLC) 42 or on an internet-based server computer 37. The data transmitted to the remote read-out means 21 can in particular also be stored in a cloud storage 38.

The presence of an operator in the immediate vicinity of the admixing system 1 is thus no longer required for maintenance, whereby entirely remote maintenance operation is enabled.

During maintenance operation, no extinguishing water is supplied to the admixing system 1 from an extinguishing water tank or from an extinguishing water supply line; i.e. extinguishing water does not flow through the fire extinguishant supply-side end 19 of the fire extinguishant inlet line 17. Correspondingly, nor does the admixing system 1 dispense any extinguishing water or premix to the points(s) of use; i.e. nor does extinguishing water/premix flow through the outlet-side end 12 of the mixing line 10. As such, maintenance operation is virtually “autarkic,” thus there being no exchange of extinguishing water or premix between the admixing system 1 and the other components of the fire-extinguishing unit.

Instead, the extinguishing water circulates in a line circuit which substantially consists of a bypass line 22, more precisely the part of the mixing line 10 between the motor-side end 11 of the mixing line 10 and the motor output-side end 24 of the bypass line 22, the bypass line 22 itself and the part of the fire extinguishant inlet line 17 between the motor input-side end 23 of the bypass line 22 and the motor-side end 18 of the fire extinguishant inlet line 17. The water motor 2 closes this line circuit between the motor-side end 18 of the fire extinguishant inlet line 17 and the motor-side end 11 of the mixing line 10.

Furthermore, a flow rate measuring device 32, in particular a magnetic-inductive flow meter (MID), to be described in greater detail below, as well as a cut-off valve 29 are arranged in the bypass line 22 and thus in the line circuit.

In the maintenance operation of the admixing system 1, the cut-off valve 29 is opened so that extinguishing water can flow through the line circuit. The opening and closing of the cut-off valve 29 is preferably likewise effected by the remote control means 20.

In the maintenance operation, the water motor 2 acts as a pump and pumps extinguishing water through the cited line circuit. Since the admixing system 1 in the exemplary embodiment is a so-called wet system, the lines of which are always filled with extinguishing water, or respectively fire extinguishant additive or premix, the line circuit does not need to be specially filled with extinguishing water for maintenance operation.

The invention can, however, also be implemented in a so-called dry system, the lines of which are not always filled with extinguishing water or with fire extinguishant additive or premix respectively. In this case as well, the line circuit does not necessarily need to be specially filled with extinguishing water. Instead, in place of an actual measured fire extinguishant flow, the rotational speed and the associated delivery volume of the water motor are used as a measure of the fire extinguishant flow.

Since in this case the water motor 2 is to act as a pump during the maintenance operation, it needs to be set into rotation by another drive device. To that end, the water motor 2 is connected to drive apparatus 25, an electric motor in the exemplary embodiment, which optionally has a gear, in particular a reduction gear.

The motor shaft 26 of the drive apparatus 25 is thereby connected to the motor shaft 5 of the water motor 2. Preferably, the motor shaft 5 is additionally routed out of the housing of the water motor 2 on the side opposite the mixing pump 6 for that purpose.

A freewheel 27 is additionally arranged between the drive apparatus 25 and the water motor 2 which transfers the torque of the drive apparatus 25 to the water motor 2 during the maintenance operation of the admixing system 1 and thus sets it into rotation. In the “real” operation of the admixing system 1, in which the drive apparatus 25 is at a standstill, however, there is slippage of the freewheel 27 so that the water motor 2—in this case driven by the extinguishing water flow in the fire extinguishant inlet line 17—can rotate freely.

Furthermore, a flexible coupling 28 is arranged between the drive apparatus 25 and the water motor 2 so that rotational irregularities in one of the two motors 25, 2 do not transfer to the other.

The drive apparatus 25 is switched on and off by the remote control means 20, for example using the switching functions of a PLC 42. The water motor 2 and thus the mixing pump 6 are thereby set into or out of operation.

The circulation of the extinguishing water in the line circuit and thus the proper functioning of the water motor 2 is monitored by a plurality of measuring devices, namely by a pressure measuring device 33, a flow rate measuring device 32, which in the exemplary embodiment is a magnetic-inductive flow meter (MID), as well as a temperature measuring device 34, which can also be integrated in the flow rate measuring device 32. The measured values of these measuring devices are received and transmitted by the remote read-out means 21 and are thereby available for evaluation, potentially at a remote location.

Correspondingly, the rotational speed of the water motor 2 can also be measured by an appropriate measuring device, in particular a tachometer (not depicted), and received and transmitted by the remote read-out means 21.

During the maintenance operation, the mixing pump 6 is also put into operation by its coupling to the water motor 2 and pumps fire extinguishant additive from a fire extinguishant additive container (not depicted). Since the described line circuit is not to have any exchange with the environment during the maintenance operation, no fire extinguishant additive is thereby permitted to get into mixing line 10. For this reason, the remote control means 20 brings the three-way ball valve 30 from the “Admix” position into the “Return” position during maintenance operation, whereby the fire extinguishant additive is pumped into the return line 31 instead of to mixing point 16, and from there back into the fire extinguishant additive container.

The switching of the three-way ball valve 30 between the “Admix” position and the “Return” position is effected by the remote control means 20. Preferably, the three-way ball valve 30 has an electric drive for this purpose and further preferably a device for position monitoring which is actuated or respectively monitored by the remote control means 20, in particular in the form of a PLC.

The admixing system 1 can furthermore have a two-way ball valve (not depicted) arranged in a flushing line (likewise not depicted). The flushing line branches off from the fire extinguishant inlet line 17 and leads to the feeding device 7 of the mixing pump 6. The two-way ball valve can be switched between a closed and an open position. The two-way ball valve is closed in the “real” operation of the admixing system 1. The two-way ball valve is open in a flushing operation of the admixing system 1 and clears the flushing line so that the extinguishing water can flow through it. In so doing, the mixing pump 6 can be flushed with extinguishing water.

The two-way ball valve can also have an electric drive and/or a device for position monitoring actuated or respectively monitored by the remote control means 20.

A further flow rate measuring device 36, again a magnetic-inductive flow meter (MID) in the exemplary embodiment, is arranged in the return line 31, by means of which the fire extinguishant additive flow in the return line 31 and thus the proper function of the mixing pump 6 can be monitored. The measured values of the flow rate measuring device 36 are also received and transmitted by the remote read-out means 21 and thereby available for evaluation, potentially at a remote location.

From the flow rates of the extinguishing water in the bypass line 22 and the fire extinguishant additive in the return line 31 received and transmitted during maintenance operation, the admixture rate can also be calculatively determined and compared to a given target admixture rate.

The proper functioning of the mixing pump 6 is further monitored by an oil level sensor and/or oil quality sensor 35, the measured values of which are likewise received and transmitted by the remote read-out means 21 and available for evaluation, potentially at a remote location.

### LIST OF REFERENCE NUMERALS

1 admixing system
2 water motor
3 feeding device of water motor
4 output device of water motor
5 motor shaft of water motor
6 mixing pump
7 feeding device of mixing pump
8 output device of mixing pump
9 drive shaft of mixing pump
10 mixing line
11 motor-side end of mixing line
12 outlet-side end of mixing line
13 fire extinguishant additive line
14 pump-side end of fire extinguishant additive line
mixing line-side end of fire extinguishant additive line
16 mixing point
17 fire extinguishant inlet line
18 motor-side end of fire extinguishant inlet line
19 fire extinguishant supply-side end of fire extinguishant inlet line
20 remote control means
21 remote read-out means
22 bypass line
23 motor input-side end of bypass line
24 motor output-side end of bypass line
25 drive apparatus
26 motor shaft
27 freewheel
28 flexible coupling
29 cut-off valve
30 three-way ball valve
31 return line
32 flow rate measuring device
33 pressure measuring device
34 temperature measuring device
35 oil level sensor and/or oil quality sensor
36 flow rate measuring device
37 server computer
38 cloud storage
39 local building
40 signal/control line
41 internet connection
42 PLC

What is claimed is:

1. An admixing system for fire-extinguishing units for producing a fire extinguishant and fire extinguishant additive mixture (premix) by mixing a fire extinguishant additive, in particular a foaming agent, into a fire extinguishant, in particular water, comprising:
a motor able to be driven by a flow of fire extinguishant, in particular a water motor, which has at least one feeding device for supplying the fire extinguishant to the motor, in particular from a fire extinguishant tank or from a fire extinguishant supply line, at least one output device for discharging the fire extinguishant from the motor and a motor shaft able to be driven by the motor,
a fire extinguishant inlet line having a motor-side end connected to the at least one feeding device of the motor and a fire extinguishant supply-side end able to be connected in particular to a fire extinguishant tank or to a fire extinguishant supply line,
a mixing pump for pumping the fire extinguishant additive, preferably a piston pump and further preferably a plunger pump, which has a drive shaft coupled to the motor shaft of the motor, at least one feeding device for providing the fire extinguishant additive, in particular from an extinguishant additive tank or from an extinguishant additive supply line, and at least one output device for discharging the fire extinguishant additive,
a mixing line having a motor-side end and an outlet-side end, wherein the motor-side end is fluidly connected to the at least one output device of the motor,
a fire extinguishant additive line with a pump-side end and a mixing line-side end, wherein the pump-side end is fluidly connected to the at least one output device of the mixing pump and the mixing line-side end is fluidly connected to the mixing line at a mixing point,
wherein the admixing system has remote control means for transmitting and executing a command for the automatic start-up or shut-down of the motor and of the mixing pump, and/or timing means for the automatic start-up or shut-down of the motor and of the mixing pump, wherein the remote control means and/or the timing means allow the automatic start-up or respectively shut-down of the motor and of the mixing pump without the presence of an operator at the admixing system, and
that the admixing system has remote read-out means for automatically receiving and transmitting data relating to the state of the admixing system, wherein the remote read-out means allows the automatic receiving and transmitting of this data without the presence of an operator at the admixing system.

2. The admixing system according to claim 1, wherein the admixing system further comprises a fire extinguishant pump for pumping fire extinguishant from a fire extinguishant tank and supplying to the motor, its at least one output device connected to the fire extinguishant supply-side end of the fire extinguishant inlet line, and that the remote control means and/or the timing means are configured to start up and to shut down the fire extinguishant pump.

3. The admixing system according to claim 1, wherein the fire extinguishant inlet line has a fire extinguishant valve for feeding fire extinguishant to the motors from a fire extinguishant supply line and that the remote control means and/or the timing means are configured to open and close the fire extinguishant valve.

4. The admixing system according to claim 1, wherein the admixing system further comprises a bypass line for the motor which is fluidly connected to the fire extinguishant inlet line at a motor input-side end and to the mixing line at a motor output-side end.

5. The admixing system according to claim 4, wherein the admixing system further comprises a drive apparatus configured to set the motor into rotation, and that the motor is configured to pump the fire extinguishant contained in the line circuit consisting of the part of the mixing line between the motor side-end of the mixing line and the motor output-side end of the bypass line, the bypass line and the part of the fire extinguishant inlet line between the motor input-side end of the bypass line and the motor-side end of the fire extinguishant inlet line, through said line circuit.

6. The admixing system according to claim 5, wherein the remote control means and/or the timing means are configured to start up and to shut down the drive apparatus.

7. The admixing system according to claim 5, wherein the drive apparatus a drive motor, in particular an electric motor, its motor shaft being connected to the motor shaft of the motor so as to selectively transmit torque, in particular via a freewheel and/or via a flexible coupling.

8. The admixing system according to claim 4, wherein the bypass line has a cut-off valve and the remote control means and/or the timing means are configured to open and close the cut-off valve.

9. The admixing system according to claim 4, wherein a switching device, in particular a ball valve, is arranged in the fire extinguishant additive line which further is fluidly connected to a return line, wherein the switching devices can be switched such that a flow of fire extinguishant additive from the pump-side end of the fire extinguishant additive line is selectively directed through the fire extinguishant additive line to the mixing point or into the return line, and wherein the remote control means and/or the timing means are configured to switch the switching device.

10. The admixing system according to claim 4, wherein the bypass line has at least one first measuring device, in particular a flow rate measuring device, preferably a magnetic-inductive flow meter, a pressure measuring device or a temperature measuring device, and the remote read-out means are configured to read data from the first measuring device to transmit them.

11. The admixing system according to claim 1, wherein the mixing pump has at least one second measuring device, in particular an oil level sensor and/or an oil quality sensor, and the remote read-out means are configured to read data from the second measuring device and to transmit them.

12. The admixing system according to claim 1, wherein the return line has at least one third measuring device, preferably a flow rate measuring device and further preferably a magnetic-inductive flow meter, and the remote read-out means are configured to read data from the third measuring device and to transmit them.

13. The admixing system according to claim 1, wherein the motor has at least one fourth measuring device, in particular a tachometer, and the remote read-out means are configured to read data from the fourth measuring device and to transmit them.

14. The admixing system according to claim 1, wherein the remote control means are arranged remotely from the components of the admixing system for which the remote control means is configured to start up and shut down, and/or the remote read-out means are arranged remotely from the components of the admixing system for which the remote read-out means is configured to receive data from and to transmit them, in particular on a remote server computer.

15. The admixing system according to claim 1, wherein the data transmitted by the remote read-out means can be stored remotely from the components of the admixing system for which the remote read-out means is configured to receive data from and to transmit them, in particular in a memory of a remote server computer or in a cloud storage.

16. A method for the maintenance of an admixing system according to claim 1 having the steps:
the remote control means and/or timing means starting up the motor and the mixing pump,
the remote read-out means receiving and transmitting data relating to the state of the admixing system, and
the remote control means and/or timing means shutting down the motor and the mixing pump.

17. The method according to claim 16, wherein the following step is performed prior to starting up the motor and the mixing pump:
the remote control means and/or timing means switching the switching device in the fire extinguishant additive line such that a flow of fire extinguishant additive is directed from the pump-side end of the fire extinguishant additive line into the return line,
and that the following step is performed subsequent to shutting down the motor and the mixing pump:
the remote control means and/or timing means switching the switching device in the fire extinguishant additive line such that a flow of fire extinguishant additive is directed through the fire extinguishant additive line from the pump-side end of the fire extinguishant additive line to the mixing point.
